(19) United States
(12) Patent Application Publication
(10) Pub. No.: US 2002/0081443 A1
(43) Pub. Date: Jun. 27, 2002

(54) Method of manufacturing circuit laminates

(76) Inventors: Susan M. Connelly, Tolland, CT (US); Ki-Soo Kim, Ashford, CT (US); Michael St. Lawrence, Thompson, CT (US); Richard T. Traskos, Brooklyn, CT (US)

Correspondence Address: CANTOR COLBURN, LLP, 55 GRIFFIN ROAD SOUTH, BLOOMFIELD, CT, 06002

(21) Appl. No.: 09/878,127

(22) Filed: Jun. 8, 2001

Related U.S. Application Data
(60) Provisional application No. 60/210,311, filed on Jun. 8, 2000.

(51) Int. Cl. B32B 15/08; B32B 31/20

(52) U.S. Cl. 428/458; 428/626; 156/308.2

(57) ABSTRACT

A method of making liquid crystalline polymer-copper laminates comprising laminating liquid crystalline polymer film to a copper foil wherein the copper foil has a surface concentration of zinc of less than or equal to about 2 atomic % and a surface concentration of chromium of less than or equal to about 4 atomic %, based on surface atomic concentration. Preferably the copper foil further comprises a dendritic layer. The copper foil may optionally be coated with a hydrophobic layer prior to lamination. The liquid crystalline polymer/copper laminate exhibits significantly improved bond strength retention compared to the prior art, particularly after being subjected to conditions of high humidity and temperature for 24 hours or more.

### CROSS REFERENCE TO RELATED APPLLICATION

This application is based on, and claims benefit of U.S. Provisional Patent Application Ser. No. 60/210,311, filed Jun. 8, 2000, the disclosures of which are herein incorporated by reference in their entirety.

### BACKGROUND OF THE INVENTION

1. Technical Field

This invention relates to methods of making laminates for circuit boards. In particular, this invention relates to methods of making circuit board laminates comprising liquid crystalline polymer films and a conductive metal.

2. Description of the Related Art

Liquid crystalline polymer (LCP) films are highly suitable for use in making circuit board substrates because they typically exhibit low moisture absorption, excellent heat resistance, high frequency properties and dimensional stability. Generally, the LCP film is laminated to a conductive metal, such as copper foil, to form an LCP-copper laminate. The LCP-copper laminate can then be used in the manufacture of printed circuit boards.

The bulk of the copper used in the printed circuit board industry is electrodeposited foil. The electrodeposited foil is treated to improve the cohesive strength of the laminate. Typically the treatment involves the following steps. A nodularized or dendritic copper layer is first deposited on the foil surface. This dendritic layer can be applied to either the matte side or the shiny side of the foil, or to both sides of the foil. The dendritic layer is applied to roughen and thereby increase mechanical interlocking between the dielectric substrate and foil surface, in order to increase the adhesion strength of the foil. The dendritic layer can optionally be coated with an encapsulation layer to hold the powdery dendritic layer on the foil. A barrier layer is then deposited on the copper. This barrier layer is added to prevent possible thermal degradation of the metal-resin interface, thereby maintaining adhesion (bond) of the foil to the resin. A stain-proof layer, generally comprising zinc and chromium, is then applied to both sides of the foil. The stain-proof layer aids in oxidation resistance, shelf life and humidity durability of the foil. Oxidation (also known as staining or tarnishing) can affect the bond strength of the laminate. Finally, a silane layer is applied over the stain-proof layer to enhance adhesion and to improve humidity durability.

In the past, stain resistance has been imparted to copper and copper base alloy materials by a variety of stain-proof layers. U.S. Pat. No. 3,625,844 to McKean and U.S. Pat. No. 3,853,716 to Yates et al. describe methods of stain-proofing copper foil comprising the electrolytic treatment of the foil in a aqueous electrolyte containing hexavalent chromium ions. U.S. Pat. No. 4,387,006 to Kajiwara et al. discloses coating a copper foil with zinc chromate. The coating is deposited from an aqueous solution containing in excess of 1.0 g/l of both zinc and chromium (VI) ions. U.S. Pat. Nos. 3,677,828, 3,716,427 and 3,764,400, all to Caule, illustrate the use of phosphoric acid solutions to improve the tarnish resistance of copper and copper-based alloys. Finally, U.S. Pat. No. 4,647,315 to Parthasarathi et al. discloses a dilute aqueous chromic acid-phosphoric acid solution for use in stain proofing.

As previously indicated, the stain-proof layer can contribute to laminate bond strength, also known as peel strength. High peel strength (the force necessary to pull apart the copper foil and the supporting insulating substrate material) is a characteristic of the highest importance, since the mechanical support of the circuit elements, as well as the current carrying capability of printed circuit boards, is provided by a strong copper foil-LCP interface. It is essential that the foil is bonded very tightly and securely to the substrate and also that such an adhesive interface can withstand all the manufacturing steps in printed circuit board fabrication without a decrease of adhesion, which, moreover should remain constant throughout the service life of the printed circuit board in all conditions, including high humidity.

Bond strength over the service life of the laminate is examined by aging the laminate in simulated conditions and then testing the laminate. Simulated conditions of high humidity are referred to as the Pressure Cooker Test (PCT), wherein the laminate is kept at 100% humidity and >100° C. for a given amount of time, then tested for bond strength using the peel test. Retaining greater than 60% peel strength after a Pressure Cooker Test is desirable.

### SUMMARY OF THE INVENTION

The above-discussed and other drawbacks and deficiencies of the prior art are overcome or alleviated by a method of making liquid crystalline polymer-copper laminates comprising laminating liquid crystalline polymer film to a metal foil, in particular a copper foil, comprising on its surface a metal selected from the group consisting of zinc, chromium, and mixtures of zinc and chromium wherein the concentration of zinc is less than or equal to about 2 atomic % and the concentration of chromium is less than or equal to about 4 atomic %, based on surface atomic concentration. The concentration of zinc, chromium, or both may be zero. Preferably the copper foil further comprises a dendritic layer. The copper foil may optionally be coated with a hydrophobic layer prior to lamination. Surprisingly, it was that low levels of zinc and/or chromium on the copper surface, which typically are found as a result of applying a stain-proof coating, were useful for establishing and maintaining good bond strength.

Another embodiment is a laminate comprising a liquid polymer film laminated to a copper foil wherein the copper foil has a surface concentration of zinc of about 0.01 to about 2 atomic %, and a surface concentration of chromium of about 0.01 to about 4 atomic %, based on surface atomic concentration.

Another embodiment is a circuit board material comprising at least one layer of copper foil laminated to at least one layer of liquid crystalline polymer film wherein the copper foil has a surface concentration of zinc of about 0.01 to about 2 atomic %, and a surface concentration of chromium of about 0.01 to about 4 atomic %, based on surface atomic concentration.

The above discussed and other features and advantages of the present invention will be appreciated and understood by those skilled in the art from the following detailed description and drawings.

### BRIEF DESCRIPTION OF THE DRAWINGS

Referring now to the exemplary drawings wherein like elements are numbered alike in the several FIGURES:

FIG. 1 shows the configuration of the laminate.

FIGS. 2-5 show various circuit board material configurations described herein.

### DETAILED DESCRIPTION OF THE PREFERRED EMBODIMENTS

A method of making liquid crystalline polymer/copper laminates comprises laminating a liquid crystalline polymer film to a copper foil wherein the copper foil has a surface concentration of chromium of less than or equal to about 4 atomic % and a surface concentration of zinc of less than or equal to about 2 atomic %, as measured by x-ray photoelectron spectroscopy (XPS). Preferably the copper foil further comprises a dendritic layer. The copper foil may optionally be coated with a hydrophobic coating prior to lamination. The liquid crystalline polymer/copper laminate exhibits significant improvement in bond strength retention compared to the prior art, particularly after being subjected to conditions of high humidity and temperature for 24 hours or more.

Liquid crystalline films are made of liquid crystalline polymers. Liquid crystalline polymers are known polymers that are believed to have a fixed molecular shape, e.g. linear, or the like, due to the nature of the monomeric repeating units comprising the polymeric chain. The monomeric units are typically aromatic. Liquid crystalline polymers can be blended with polymers that are not liquid crystalline polymers, hereinafter referred to as coil-like polymers. Some of these blends have processing and functional characteristics similar to liquid crystalline polymers. Films comprising these blends are thus included in the present invention.

Films comprising thermotropic and/or lyotropic liquid crystalline polymers are suitable for use in forming laminates. Suitable thermotropic liquid crystalline polymers are known, and include aromatic polyesters that exhibit liquid crystal properties when melted and which are synthesized from aromatic diols, aromatic carboxylic acids, hydroxycarboxylic acids and other like monomers. A preferred liquid crystalline polymer film is based on copolymer of hydroxy benzoate/hydroxy naphthoate, known commercially as VECSTAR, available from Kuraray Co., Ltd., Japan. Preferably liquid crystalline polymer films are fully isotropic or multiaxially oriented. Useful films typically have a thickness of about 25 micrometers to about 500 micrometers. The liquid crystalline polymer films have, in general, low moisture absorption, excellent dimensional stability and superior electrical properties.

The liquid crystalline polymer film may also comprise solid particulate filler material. The solid particulate filler material can be an organic or inorganic material having a melt temperature higher than the liquid crystalline polymer with which it is mixed. Suitable inorganic fillers include, but are not limited to, silica, alumina, titanium oxide, and other metal oxides; carbonates, such as calcium carbonate and barium carbonate; sulfates, such as calcium sulfate and barium sulfate; titanates, such as potassium titanate and calcium titanate; talc, clay, mica, glass, and other silicates. Examples of suitable organic filler particles include carbon, graphite, and high melt-temperature resin powders of synthetic polymers such as polyimides, polyetherimides, polyamideimides, polyetheretherketones, and fluoropolymers such as polytetrafluoroethylene (PTFE), tetrafluoroethylene-hexafluoropropylene copolymer (FEP), tetrafluoroethylene-(perfluoroalkyl) vinyl ether copolymer (PFA), ethylene/tetrafluoroethylene copolymer (ETFE), polytrichlorofluoroethylene (CTFE), polyvinylidene fluoride (PVDF), and the like. By “particulate” is meant individual particles of any aspect ratio and thus includes fibers and powders.

The particulate filler material preferably has mean particle size in the range 0.01 to 50 micrometers, preferably in the range 0.1 to 10 micrometers. The concentration of particulate material in the liquid crystalline polymer film should be in the range of about 0.01% to about 50% by weight, preferably in the range of about 0.1% to about 30% by weight. The fillers may be treated with a silanation or zirconation agent to increase hydrophobicity, and improve incorporation and bonding with the polymer as is known in the art.

Useful copper foils are electrodeposited copper foils that comprise less than or equal to about 4 atomic % chromium and less than or equal to about 2 atomic % zinc on their surface. The surface composition of the samples may be analyzed by electron spectroscopy of chemical analysis (ESCA), also known as x-ray electron photo spectroscopy (XPS), preferably without modification within an area having a diameter of about 1 mm. A typical take-off angle of 65° with respect to the analyzed surface is common. Monochromatic Al K-alpha radiation can be utilized for the measurement. The depth of the surface analyzed is estimated to be 70 angstroms or less. It was discovered that bond strength retention after PCT is related to the quantity of zinc and chromium on the surface of the foil. The stain-proof layer is the typically the source of the zinc and chromium on electrodeposited copper foils, although the barrier layer can also contain zinc and chromium. Useful copper foils have a very low surface content of zinc, less than or equal to about 2 atomic %, and preferably about 0.01 atomic % to about 1 atomic % and furthermore, a low chromium surface content, less than or equal to about 4 atomic % and preferably less than or equal to about 3 atomic %. The surface content of the zinc and/or the chromium may be zero. Examples of suitable electrodeposited copper foils having these surface quantities of chromium and zinc are available under the trade name NT-TAX-M and NT-TAX-O, available from Yates Foil USA. The foil can have thicknesses of about 1 to about 72 micrometers, preferably thicknesses from about 5 to about 40 micrometers.

In a preferred embodiment, the copper foil is treated to form a hydrophobic coating to improve the resistance to water absorption, ductility and copper bond strength of the laminate. Examples of efficacious and known hydrophobic coatings are silane coupling agents, titanates and zirconates.

The LCP films may be laminated to the copper foils by any of the suitable methods known in the art. Possible lamination methods for coated copper foils include, but are not limited to, a lamination press, autoclave, continuous roll-to-roll lamination, among others, with the preferred method based upon the type of liquid crystalline polymer employed.

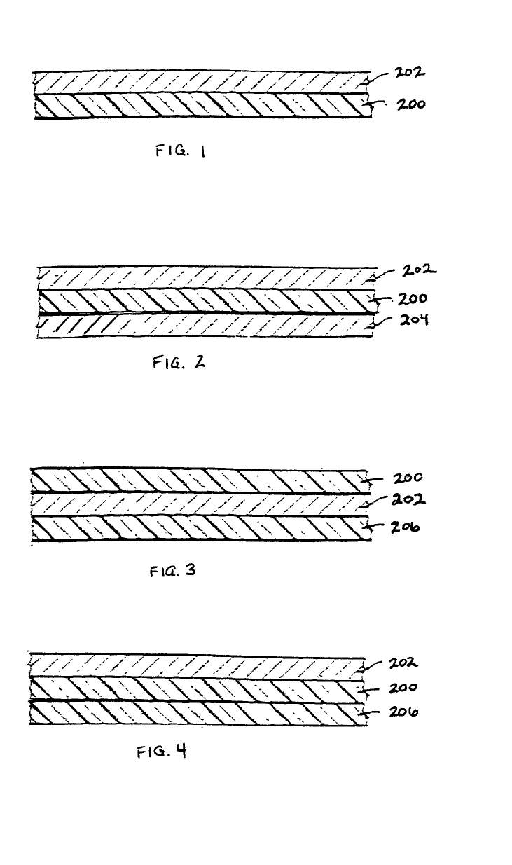

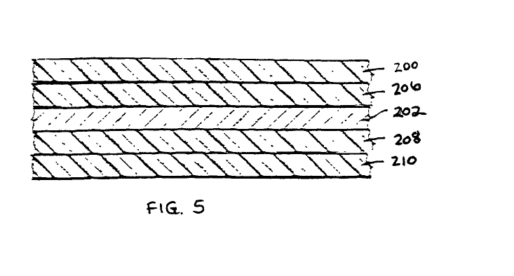

With reference now to FIG. 1, it is contemplated that the laminate may comprise a single layer of liquid crystalline polymer 200 and a single copper layer 202 laminated thereto. As shown in FIG. 2, a circuit board material may comprise a single layer of liquid crystalline polymer 200 is disposed between a first copper layer 202 and a second copper layer 204. Alternatively, as shown in FIG. 3, a circuit board material may comprise a single copper layer 202 is disposed between a first liquid crystalline polymer layer 200 and a second liquid crystalline polymer layer 206. In FIG. 4 is shown another embodiment of a circuit board material comprising a single copper layer 202 having disposed thereon multiple liquid crystalline polymer layers 200, 206. FIG. 5 shows a circuit board material comprising a copper layer 202 with multiple liquid crystalline polymer layers 200, 206 disposed on a first side of copper layer 202 and multiple liquid crystalline polymer layers 208, 210 disposed on a second side of copper layer 202.

The invention is further illustrated by the following non-limiting Examples.

### EXAMPLES

### Examples 1-7

Laminates were prepared using a liquid crystalline polymer film available from Kuraray Co., Ltd. The zinc and chromium surface content of the copper foil was varied as shown in Table 1. XPS data was provided by Katz Analytical Services, Chanhassen, Minn. Examples 1 and 2 are comparative examples. The liquid crystalline polymer film (50 micrometers thick) was laminated between two layers of 18 micrometer thick copper foil at 280-350° C. under pressure using a hot press. The laminates were subjected to etching to produce peel test samples with 3.175 millimeter copper traces on one side and full copper on the other side. The peel test samples were then aged at 105° C. and 5 pounds (2.3 kilograms) of pressure for 48 hours (PCT test). Bond strength was measured in pounds per linear inch (pli) using a peel test before and after the PCT test.

TABLE 1

| Example | Atomic % | Atomic % | Peel strength | Peel strength | % Loss in |
|---|---|---|---|---|---|
| No. | Zn | Cr | before PCT (pli) | after PCT (pli) | peel strength |
| 1* | 9.04 | 2.95 | 6.3 | 2.4 | 62 |
| 2* | 9.04 | 2.95 | 6.8 | 2.7 | 60 |
| 3 | 0.30 | 2.46 | 6.8 | 4.6 | 32 |
| 4 | 0.36 | 2.81 | 6.4 | 4.5 | 30 |
| 5 | 0.86 | 2.86 | 5.6 | 3.9 | 30 |
| 6 | 0.64 | 0 | 5.6 | 4.4 | 21 |
| 7 | 0 | 0 | 5.5 | 3.6 | 35 |

*Comparative examples

Comparative examples 1-2 clearly show a 60-62% loss in bond strength following exposure to PCT conditions. In contrast, examples 3 through 7 show marked improvement, limiting bond strength loss to 35% or less. Example 6 shows a bond strength loss of only 21%. Low levels of zinc and chromium clearly improve the bond strength of the laminate after exposure of the bond to PCT conditions.

### Examples 8-9

Laminates were prepared as in Examples 1-7. Example 9 is a comparative example. The laminates were subjected to etching to produce peel test samples with 3.175 millimeter copper traces on one side and no copper on the other side. The peel test samples were then and aged at 121° C. and 16 pounds (17.3 kilograms) of pressure for 6 days (PCT test). Bond strength was measured in pounds per linear inch (pli) using a peel test before and after the PCT test.

TABLE 2

| Example | Atomic % | Atomic % | Peel strength | Peel strength | % Loss in |
|---|---|---|---|---|---|
| No. | Zn | Cr | before PCT (pli) | after PCT (pli) | peel strength |
| 8 | 0.36 | 2.8 | 3.0 | 1.76 | 41 |
| 9* | 3.2 | 2.5 | 3.0 | 0.4 | 87 |

*Comparative example

Example 8 clearly shows that low levels of zinc and chromium improve the bond strength even after long exposure to PCT conditions.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A method of making liquid crystalline polymer-copper laminates comprising laminating liquid crystalline polymer film to a copper foil, wherein the copper foil has a surface concentration of zinc of about 0.01 to about 2 atomic %, based on surface atomic concentration.

2. The method of claim 1, wherein concentration of zinc is about 0.01 to about 1 atomic %.

3. The method of claim 1, wherein the liquid crystalline polymer film comprises a hydroxy benzoate/hydroxynapthoate copolymer having a thickness of about 25 micrometers to about 500 micrometers.

4. The method of claim 1, wherein the copper foil has a thickness of about 1 to about 72 micrometers.

5. The method of claim 4, wherein the copper foil has a thickness of about 5 to about 40 micrometers.

6. The method of claim 1, wherein the copper foil further comprises a dendritic layer, a hydrophobic layer or both.

7. A method of making liquid crystalline polymer-copper laminates comprising laminating liquid crystalline polymer film to a copper foil, wherein the copper foil has a surface concentration of zinc of less than or equal to about 2 atomic %, based on surface atomic concentration.

8. The method of claim 7, wherein the concentration of zinc is up to about 1 atomic %.

9. The method of claim 7, wherein the concentration of zinc is zero.

10. The method of claim 7, wherein the liquid crystalline polymer film comprises a hydroxy benzoate/hydroxynapthoate copolymer having a thickness of about 25 micrometers to about 500 micrometers.

11. The method of claim 7, wherein the copper foil has a thickness of about 1 to about 72 micrometers.

12. The method of claim 11, wherein the copper foil has a thickness of about 5 to about 40 micrometers.

13. The method of claim 7, wherein the copper foil further comprises a dendritic layer, a hydrophobic layer or both.

14. A laminate comprising:
a copper foil and a liquid polymer film laminated thereto, wherein the copper foil has a surface concentration of zinc of about 0.01 to about 2 atomic %, based on surface atomic concentration;.

15. The laminate of claim 14, wherein the concentration of zinc is about 0.01 to about 1 atomic %.

16. The laminate of claim 14, wherein the liquid crystalline polymer film comprises a hydroxy benzoate/hydroxynapthoate copolymer having a thickness of about 25 micrometers to about 500 micrometers.

17. The laminate of claim 14, wherein the copper foil has a thickness of about 1 to about 72 micrometers.

18. The laminate of claim 17, wherein the copper foil has a thickness of about 5 to about 40 micrometers.

19. The laminate of claim 14, wherein the copper foil further comprises a dendritic layer, a hydrophobic layer or both.

20. The laminate of claim 14, wherein the percent loss of peel strength is less than or equal to 35% after being aged at 105° C. and 5 pounds (2.3 kilograms) of pressure for 48 hours.

21. The laminate of claim 14, wherein the percent loss of peel strength is less than or equal to 30% after being aged at 105° C. and 5 pounds (2.3 kilograms) of pressure for 48 hours.

22. A laminate comprising:
a copper foil and a liquid polymer film laminated thereto, wherein the copper foil has a surface concentration of zinc of less than or equal to about 2 atomic %, based on surface atomic concentration.

23. The laminate of claim 22, wherein concentration of zinc is up to about 1 atomic %.

24. The laminate of claim 22, wherein the concentration of zinc is zero.

25. The laminate of claim 22, wherein the liquid crystalline polymer film comprises a hydroxy benzoate/hydroxynapthoate copolymer having a thickness of about 25 micrometers to about 500 micrometers.

26. The laminate of claim 22, wherein the copper foil has a thickness of about 1 to about 50 micrometers.

27. The laminate of claim 26, wherein the copper foil has a thickness of about 5 to about 40 micrometers.

28. The laminate of claim 22, wherein the copper foil further comprises a dendritic layer, a hydrophobic layer or both.

29. A circuit board material comprising a copper foil and a liquid polymer film laminated thereto, wherein the copper foil has a surface concentration of zinc of about 0.01 to about 2 atomic %, based on surface atomic concentration;.

30. The circuit board material of claim 29, wherein the concentration of zinc is about 0.01 to about 1 atomic %.

31. The circuit board material of claim 29, wherein the liquid crystalline polymer film comprises a hydroxy benzoate/hydroxynapthoate copolymer having a thickness of about 25 micrometers to about 500 micrometers.

32. The circuit board material of claim 29, wherein the copper foil has a thickness of about 1 to about 50 micrometers.

33. The circuit board material of claim 32, wherein the copper foil has a thickness of about 5 to about 40 micrometers.

34. The circuit board material of claim 29, wherein the copper foil further comprises a dendritic layer, a hydrophobic layer or both.

35. A circuit board material comprising:
a copper foil and a liquid polymer film laminated thereto, wherein the copper foil has a surface concentration of zinc of less than or equal to about 2 atomic %, based on surface atomic concentration.

36. The circuit board material of claim 35, wherein the concentration of zinc is up to about 1 atomic %.

37. The circuit board material of claim 35, wherein the concentration of zinc is zero.

38. The circuit board material of claim 35, wherein the liquid crystalline polymer film comprises a hydroxy benzoate/hydroxynapthoate copolymer having a thickness of about 25 micrometers to about 500 micrometers.

39. The circuit board material of claim 35, wherein the copper foil has a thickness of about 1 to about 50 micrometers.

40. The circuit board material of claim 39, wherein the copper foil has a thickness of about 5 to about 40 micrometers.

41. The circuit board material of claim 35, wherein the copper foil further comprises a dendritic layer, a hydrophobic layer or both.

42. A method of making liquid crystalline polymer-copper laminates comprising laminating liquid crystalline polymer film to a copper foil, wherein the copper foil has a surface concentration of zinc of about 0.01 to about 2 atomic %, and a surface concentration of chromium of about 0.01 to about 4 atomic %, based on surface atomic concentration.

43. The method of claim 42, wherein concentration of zinc is about 0.01 to about 1 atomic %.

44. The method of claim 42, wherein the concentration of chromium is about 0.01 to about 3 atomic %.

45. The method of claim 42, wherein the liquid crystalline polymer film comprises a hydroxy benzoate/hydroxynapthoate copolymer having a thickness of about 25 micrometers to about 500 micrometers.

46. The method of claim 42, wherein the copper foil has a thickness of about 1 to about 72 micrometers.

47. The method of claim 46, wherein the copper foil has a thickness of about 5 to about 40 micrometers.

48. The method of claim 42, wherein the copper foil further comprises a dendritic layer, a hydrophobic layer or both.

49. A method of making liquid crystalline polymer-copper laminates comprising laminating liquid crystalline polymer film to a copper foil, wherein the copper foil has a surface concentration of zinc of less than or equal to about 2 atomic % and a surface concentration of chromium of less than or equal to about 4 atomic % based on surface atomic concentration.

50. The method of claim 49, wherein the concentration of zinc is up to about 1 atomic %.

51. The method claim 49, wherein the concentration of chromium is up to about 3 atomic %.

52. The method of claim 49, wherein the concentration of zinc, the concentration of chromium, or both is zero.

53. The method of claim 49, wherein the liquid crystalline polymer film comprises a hydroxy benzoate/hydroxynapthoate copolymer having a thickness of about 25 micrometers to about 500 micrometers.

54. The method of claim 49, wherein the copper foil has a thickness of about 1 to about 72 micrometers.

55. The method of claim 54, wherein the copper foil has a thickness of about 5 to about 40 micrometers.

56. The method of claim 49, wherein the copper foil further comprises a dendritic layer, a hydrophobic layer or both.

57. A laminate comprising:
a copper foil and a liquid polymer film laminated thereto, wherein the copper foil has a surface concentration of zinc of about 0.01 to about 2 atomic %, and a surface concentration of chromium of about 0.01 to about 4 atomic %, based on surface atomic concentration;.

58. The laminate of claim 57, wherein the concentration of zinc is about 0.01 to about 1 atomic %.

59. The laminate of claim 57, wherein the concentration of chromium is about 0.01 to about 3 atomic %.

60. The laminate of claim 57, wherein the liquid crystalline polymer film comprises a hydroxy benzoate/hydroxynapthoate copolymer having a thickness of about 25 micrometers to about 500 micrometers.

61. The laminate of claim 57, wherein the copper foil has a thickness of about 1 to about 72 micrometers.

62. The laminate of claim 61, wherein the copper foil has a thickness of about 5 to about 40 micrometers.

63. The laminate of claim 57, wherein the copper foil further comprises a dendritic layer, a hydrophobic layer or both.

64. The laminate of claim 57, wherein the percent loss of peel strength is less than or equal to 35% after being aged at 105° C. and 5 pounds (2.3 kilograms) of pressure for 48 hours.

65. The laminate of claim 57, wherein the percent loss of peel strength is less than or equal to 30% after being aged at 105° C. and 5 pounds (2.3 kilograms) of pressure for 48 hours.

66. A laminate comprising:
a copper foil and a liquid polymer film laminated thereto, wherein the copper foil has a surface concentration of zinc of less than or equal to about 2 atomic % and a surface concentration of chromium of less than or equal to about 4 atomic %, based on surface atomic concentration;.

67. The laminate of claim 66, wherein the concentration of zinc is up to about 1 atomic %.

68. The laminate of claim 66, wherein the concentration of chromium is up to about 3 atomic %.

69. The laminate of claim 66, wherein the concentration of zinc, the concentration of chromium, or both is zero.

70. The laminate of claim 66, wherein the liquid crystalline polymer film comprises a hydroxy benzoate/hydroxynapthoate copolymer having a thickness of about 25 micrometers to about 500 micrometers.

71. The laminate of claim 66, wherein the copper foil has a thickness of about 1 to about 50 micrometers.

72. The laminate of claim 71, wherein the copper foil has a thickness of about 5 to about 40 micrometers.

73. The laminate of claim 66, wherein the copper foil further comprises a dendritic layer, a hydrophobic layer or both.

74. A circuit board material comprising:
a copper foil and a liquid polymer film laminated thereto, wherein the copper foil has a surface concentration of zinc of about 0.01 to about 2 atomic %, and a surface concentration of chromium of about 0.01 to about 4 atomic %, based on surface atomic concentration;.

75. The circuit board material of claim 74, wherein the concentration of zinc is about 0.01 to about 1 atomic %.

76. The circuit board material of claim 74, wherein the cocentration of chromium is about 0.01 to about 3 atomic %.

77. The circuit board material of claim 74, wherein the liquid crystalline polymer film comprises a hydroxy benzoate/hydroxynapthoate copolymer having a thickness of about 25 micrometers to about 500 micrometers.

78. The circuit board material of claim 74, wherein the copper foil has a thickness of about 1 to about 50 micrometers.

79. The circuit board material of claim 78, wherein the copper foil has a thickness of about 5 to about 40 micrometers.

80. The circuit board material of claim 74, wherein the copper foil further comprises a dendritic layer, a hydrophobic layer or both.

81. A circuit board material comprising:
a copper foil and a liquid polymer film laminated thereto, wherein the copper foil has a surface concentration of zinc of less than or equal to about 2 atomic % and a surface concentration of chromium of less than or equal to about 4 atomic %, based on surface atomic concentration.

82. The circuit board material of claim 81, wherein the concentration of zinc is up to about 1 atomic %.

83. The circuit board material of claim 81, wherein the concentration of chromium is up to about 3 atomic %.

84. The circuit board material of claim 81, wherein the concentration of zinc, the concentration of chromium, or both is zero.

85. The circuit board material of claim 81, wherein the liquid crystalline polymer film comprises a hydroxy benzoate/hydroxynapthoate copolymer having a thickness of about 25 micrometers to about 500 micrometers.

86. The circuit board material of claim 81, wherein the copper foil has a thickness of about 1 to about 50 micrometers.

87. The circuit board material of claim 86, wherein the copper foil has a thickness of about 5 to about 40 micrometers.

88. The circuit board material of claim 81, wherein the copper foil further comprises a dendritic layer, a hydrophobic layer or both.
